(19) United States
(12) Patent Application Publication
(10) Pub. No.: US 2026/0024704 A1
(43) Pub. Date: Jan. 22, 2026

(54) CERAMIC ELECTRONIC COMPONENT AND METHOD OF MANUFACTURING THE SAME

(71) Applicant: NGK INSULATORS, LTD., Nagoya-shi (JP)

(72) Inventors: Ryusuke IKEDA, Ichinomiya-shi (JP); Hiroki OBATA, Tsuru-shi (JP); Tomohiko HIBINO, Inazawa-shi (JP); Isamu OGUMA, Machida-shi (JP); Hiroto KODERA, Hachioji-shi (JP)

(21) Appl. No.: 19/341,536

(22) Filed: Sep. 26, 2025

Related U.S. Application Data
(63) Continuation of application No. PCT/JP2024/006007, filed on Feb. 20, 2024.

(30) Foreign Application Priority Data
Mar. 31, 2023 (JP) 2023-058510

(51) Int. Cl. H01G 4/232; H01G 4/012; H01G 4/30

(52) U.S. Cl. CPC H01G 4/2325; H01G 4/012; H01G 4/30

(57) ABSTRACT

A main body has a first surface, and a second surface opposite to the first surface, the main body including a ceramic portion. At least one external electrode includes a first portion on the first surface of the main body. A fluorine compound exists on a surface of the first portion of the at least one external electrode.

### CROSS-REFERENCE TO RELATED APPLICATION

This application is a continuation application of PCT/JP2024/006007, filed on Feb. 20, 2024, which claims the benefit of priority of Japanese Patent Application No. 2023-058510, filed on Mar. 31, 2023, the entire contents of which are incorporated herein by reference.

### BACKGROUND

### Technical Field

The present invention relates to a ceramic electronic component, and particularly to a ceramic electronic component including an external electrode.

### Description of the Background Art

According to Japanese Patent Application Laid-Open No. H11-186696, an angle formed between a lower surface of a ceramic electronic component such as a capacitor, a coil, a resistor, or a filter and a bonding material (specifically, solder) for mounting the ceramic electronic component on a substrate is an obtuse angle. This structure intends to prevent a break in the ceramic electronic component which is caused by mechanical stress on the substrate.

According to WO2015/066957, an external electrode of a ceramic device contains gold (Au) in addition to, for example, platinum as a main material. This structure intends to enhance reliability on bonding the external electrode to a low melting point solder for mounting the ceramic device. In connection with this, disclosed is that wettability with a low melting point solder will be improved when an Au content in an external electrode is 3 wt % or higher.

### SUMMARY

In connection with mounting ceramic electronic components, there are cases where resin films are formed by applying and curing liquid resin materials. In such cases, whether the liquid resin materials are appropriately applied affects the mounting reliability. This has not been fully considered until now.

The present invention has been conceived to solve the problem, and has an object of providing a ceramic electronic component with enhanced mounting reliability.
Aspect 1 is a ceramic electronic component (701 to 703) including: a main body (100) having a first surface (S1) and a second surface (S2) opposite to the first surface (S1), the main body (100) including a ceramic portion (10); and at least one external electrode (200) including a first portion (211, 221, 230, 251) located on the first surface (S1) of the main body (100). A fluorine compound (400) exists on a surface of the first portion (211, 221; 230; 251) of the at least one external electrode (200).
Aspect 2 is the ceramic electronic component (701 to 703) according to Aspect 1, wherein the fluorine compound exists on the surface of the first portion (211, 221; 230; 251) of the at least one external electrode (200) at a peak ratio larger than or equal to 0.06 and smaller than or equal to 1.18. Aspect 3 is the ceramic electronic component (701 to 703) according to Aspect 1 or 2, wherein the fluorine compound exists on the surface of the first portion (211, 221; 230; 251) of the at least one external electrode (200) at a peak ratio larger than or equal to 0.10 and smaller than or equal to 1.18. Aspect 4 is the ceramic electronic component (701 to 703) according to any one of Aspect 1 to Aspect 3, wherein the fluorine compound exists on the surface of the first portion (211, 221; 230; 251) of the at least one external electrode (200) at a peak ratio larger than or equal to 0.20 and smaller than or equal to 0.78.
Aspect 5 is the ceramic electronic component (701 to 703) according to any one of Aspect 1 to Aspect 4, wherein the at least one external electrode (200) includes a second portion (212, 222; 240; 252, 260) located on the second surface (S2) of the main body (100).
Aspect 6 is the ceramic electronic component (701) according to Aspect 5, wherein the fluorine compound (400) exists on a surface of the second portion (212, 222; 240; 252, 260) of the at least one external electrode (200).
Aspect 7 is the ceramic electronic component (701) according to any one of Aspects 1 to 6, wherein the main body (100) has a third surface (S3) connecting the first surface (S1) to the second surface (S2), and the at least one external electrode (210) includes a third portion (213; 253) located on the third surface (S3) of the main body (100).
Aspect 8 is the ceramic electronic component (701) according to Aspect 7, wherein the main body (100) includes a first internal electrode layer (33) connected to the third portion (213) of the at least one external electrode (200).
Aspect 9 is the ceramic electronic component (701) according to Aspect 7, wherein the main body (100) has a fourth surface (S4) connecting the first surface (S1) to the second surface (S2), and the at least one external electrode (200) includes a fourth portion (223) located on the fourth surface (S4) of the main body (100).
Aspect 10 is the ceramic electronic component (701) according to Aspect 9, wherein the main body (100) includes a first internal electrode layer (33) connected to the third portion (213) of the at least one external electrode (200), and a second internal electrode layer (34) connected to the fourth portion (223) of the at least one external electrode (200).
Aspect 11 is the ceramic electronic component (701) according to any one of Aspects 1 to 10, wherein the first surface (S1) of the main body (100) includes: a first region (S1e) covered with the at least one external electrode (200); and a second region (Sin) not covered with the at least one external electrode (200), and the fluorine compound (400) exists on the second region (S1n) of the first surface (S1) of the main body (100).
Aspect 12 is the ceramic electronic component (701 to 703) according to any one of Aspects 1 to 11, wherein the at least one external electrode (200) includes an electrode containing platinum.
Aspect 13 is a method of manufacturing a ceramic electronic component (701), the method including the steps of: preparing a ceramic electronic component (701C) including an external electrode (210, 220); and bringing the external electrode (210, 220) into contact with a fluorine compound layer (1002).

The reference numerals to which parentheses are added in the aforementioned aspects are mere exemplifications for facilitating the understanding of the aspects, and do not limit the aspects.

According to the aforementioned aspects, the fluorine compound exists on the surface of the first portion of the external electrode. The wettability of the first portion of the external electrode can be controlled by adjusting the amount of this fluorine compound. This can optimize the wettability of the external electrode. Thus, the mounting reliability of the ceramic electronic component can be enhanced.

These and other objects, features, aspects, and advantages of the present invention will become more apparent from the following detailed description of the present invention when taken in conjunction with the accompanying drawings.

### BRIEF DESCRIPTION OF DRAWINGS

FIG. 1 is a cross-sectional view schematically illustrating a structure of a ceramic electronic component according to Embodiment 1.

FIG. 2 is a partial cross-sectional view schematically illustrating a structure of an electronic apparatus on which the ceramic electronic component in FIG. 1 is mounted and conductive resin films are formed with optimal spread.

FIG. 3 is a diagram schematically illustrating a case where spread of conductive resin films is excessively small when compared to those in FIG. 2.

FIG. 4 is a diagram schematically illustrating a case where spread of conductive resin films is excessively large when compared to those in FIG. 2.

FIG. 5 is a partial cross-sectional view schematically illustrating a first step of a method of manufacturing the ceramic electronic component according to Embodiment 1.

FIG. 6 is a partial cross-sectional view schematically illustrating a second step of the method of manufacturing the ceramic electronic component according to Embodiment 1.

FIG. 7 is a partial cross-sectional view schematically illustrating a third step of the method of manufacturing the ceramic electronic component according to Embodiment 1.

FIG. 8 is a partial cross-sectional view schematically illustrating a fourth step of the method of manufacturing the ceramic electronic component according to Embodiment 1.

FIG. 9 is a partial cross-sectional view schematically illustrating a fifth step of the method of manufacturing the ceramic electronic component according to Embodiment 1.

FIG. 10 is a partial cross-sectional view schematically illustrating a sixth step of the method of manufacturing the ceramic electronic component according to Embodiment 1.

FIG. 11 is a graph illustrating an example of measurement results by X-ray photoelectron spectroscopy (XPS) on surfaces of external electrodes of ceramic electronic components of Example.

FIG. 12 is a graph illustrating an example of measurement results by XPS on surfaces of external electrodes of ceramic electronic components of a comparative example.

FIG. 13 is a graph illustrating an example of more accurate XPS measurement results in a broken-line portion EF in FIG. 11.

FIG. 14 is a graph illustrating an example of more accurate XPS measurement results in a broken-line portion EP in FIG. 11.

FIG. 15 is a graph illustrating a distribution range of F/Pt in Table 1.

FIG. 16 is a cross-sectional view schematically illustrating a structure of a ceramic electronic component according to Embodiment 2.

FIG. 17 is a cross-sectional view schematically illustrating a structure of a ceramic electronic component according to Embodiment 3.

### DESCRIPTION OF THE PREFERRED EMBODIMENTS

Embodiments of the present invention will be described below based on the drawings. The same reference numerals are assigned to the same or equivalent portions in the drawings, and the description is not repeated.

### Embodiment 1

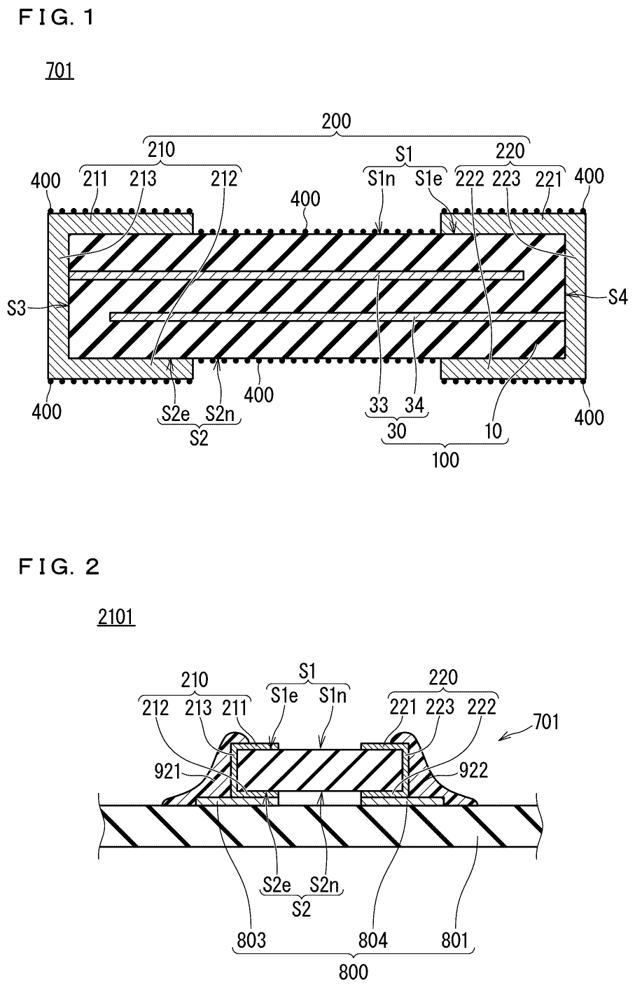

FIG. 1 is a cross-sectional view schematically illustrating a structure of a ceramic electronic component 701 according to Embodiment 1. The ceramic electronic component 701 may be a multilayered ceramic electronic component manufactured using a multilayered ceramic technology. The ceramic electronic component 701 may be a chip electronic component, for example, a chip capacitor. The ceramic electronic component 701 has dimensions of, for example, 1 mm long (a dimension in a horizontal direction in FIG. 1) by 0.1 mm thick (a dimension in a vertical direction in FIG. 1) by 0.5 mm wide.

The ceramic electronic component 701 includes a main body 100 and at least one external electrode 200. This at least one external electrode 200 includes a plurality of external electrodes 200 including a first external electrode 210 and a second external electrode 220 in the present embodiment. The at least one external electrode 200 may include an electrode containing platinum (Pt) which may be an electrode substantially made of Pt, that is, a Pt electrode. A material of the at least one external electrode 200 need not always contain Pt, but may be a material containing at least one of, for example, copper, palladium, gold, silver, nickel, tungsten, or molybdenum. The following will describe, in detail, cases where the external electrode 200 is a Pt electrode.

The main body 100 has a first surface S1 and a second surface S2 opposite to the first surface S1 in a thickness direction (the vertical direction in the drawing). Furthermore, the main body 100 has a third surface S3 connecting the first surface S1 to the second surface S2, and a fourth surface S4 connecting the first surface S1 to the second surface S2. The third surface S3 and the fourth surface S4 may be surfaces opposed to each other in a longitudinal direction (the horizontal direction in the drawing). The main body 100 includes a ceramic portion 10. Each of the first surface S1 and the second surface S2 may be a surface of the ceramic portion 10 as illustrated in FIG. 1. In other words, the first surface S1 and the second surface S2 may be the surfaces of the ceramic portion 10. The ceramic portion 10 is typically made of an insulator. In other words, the ceramic portion 10 is typically an insulating ceramic portion.

The first external electrode 210 includes a first portion 211 located on the first surface S1 of the main body 100. In the present embodiment, the first external electrode 210 includes a second portion 212 located on the second surface S2 of the main body 100, and a third portion 213 located on the third surface S3 of the main body 100.

The second external electrode 220 includes a first portion 221 located on the first surface S1 of the main body 100. In the present embodiment, the second external electrode 220 includes a second portion 222 located on the second surface S2 of the main body 100, and a fourth portion 223 located on the fourth surface S4 of the main body 100.

The main body 100 may include at least one first internal electrode layer 33 connected to the third portion 213 of the first external electrode 210. Furthermore, the main body 100 may include at least one second internal electrode layer 34 connected to the fourth portion 223 of the second external electrode 220.

A fluorine compound 400 exists on the surface of the first portion 211 of the first external electrode 210. In the present embodiment, the fluorine compound 400 also exists on the surface of the first portion 221 of the second external electrode 220. In the present embodiment, the fluorine compound 400 may also exist on the surface of the second portion 212 of the first external electrode 210 and the surface of the second portion 222 of the second external electrode 220.

In the present embodiment, the first surface S1 of the main body 100 includes a first region S1e covered with the external electrode 200 (the first external electrode 210 and the second external electrode 220 in the present embodiment), and a second region S1n not covered with the external electrode 200. Furthermore, the second surface S2 of the main body 100 includes a first region S2e covered with the external electrode 200, and a second region S2n not covered with the external electrode 200.

The fluorine compound 400 may also exist on the second region Sin of the first surface S1 of the main body 100. Furthermore, the fluorine compound 400 may also exist on the second region S2n of the second surface S2 of the main body 100. The amount of the fluorine compound 400 on the second region SIn per unit area may be lower than those on the first portions 211 and 221 of the external electrode 200. Furthermore, the amount of the fluorine compound 400 on the second region S2n per unit area may be lower than those on the second portions 212 and 222 of the external electrode 200. As a modification, the fluorine compound 400 need not exist on the second region S1n. Furthermore, the fluorine compound 400 need not exist on the second region S2n.

FIG. 2 is a partial cross-sectional view schematically illustrating a structure of an electronic apparatus 2101 on which the ceramic electronic component 701 (FIG. 1) is mounted. The electronic apparatus 2101 includes a substrate 800, the ceramic electronic component 701, and conductive resin films 921 and 922. The substrate 800 includes a base 801 made of an insulator, and wiring portions 803 and 804 made of a conductor. In the present embodiment, the third portion 213 of the first external electrode 210 of the ceramic electronic component 701 is connected to the wiring portion 803 through the conductive resin film 921. Furthermore, the fourth portion 223 of the second external electrode 220 of the ceramic electronic component 701 is connected to the wiring portion 804 through the conductive resin film 922.

The conductive resin films 921 and 922 are provided for electrically connecting the first external electrode 210 and the second external electrode 220 to the wiring portion 803 and the wiring portion 804, respectively, while highly maintaining the mounting reliability of the ceramic electronic component 701 on the substrate 800. The conductive resin films 921 and 922 are formed by applying and curing a liquid resin material. Thus, spread of each of the conductive resin films 921 and 922 is significantly affected by the wettability of the ceramic electronic component 701 with the liquid resin material. The amount of the liquid resin material to be applied for forming each of the conductive resin films 921 and 922 is normally predefined, for example, approximately 10 micro litter.

In the electronic apparatus 2101 (FIG. 2), each of the conductive resin films 921 and 922 has optimal spread. Specifically, the conductive resin film 921 reaches each of the top of the first portion 211 of the first external electrode 210 and the top of the substrate 800. Similarly, a conductive resin film 922 reaches each of the top of the first portion 221 of the second external electrode 220 and the top of the substrate 800. On the other hand, separation between the conductive resin films 921 and 922 without any contact on the first surface S1 of the main body 100 allows the first external electrode 210 and the second external electrode 220 to avoid electrical short circuits.

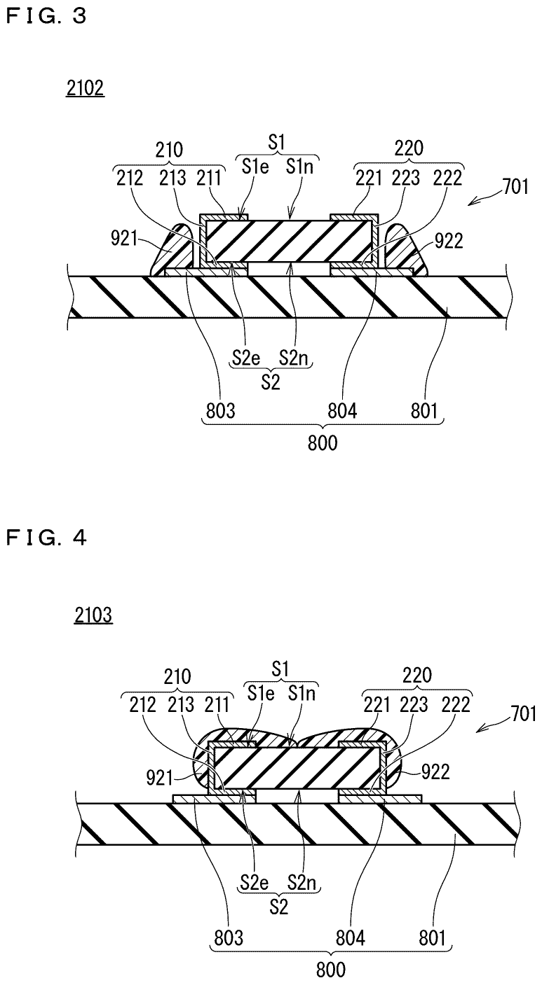

FIG. 3 is a partial cross-sectional view schematically illustrating a structure of an electronic apparatus 2102 in which spread of the conductive resin films 921 and 922 is excessively small when compared to those in the electronic apparatus 2101 (FIG. 2). Specifically, the conductive resin film 921 and the conductive resin film 922 do not reach the top of the first portion 211 of the first external electrode 210 and the top of the first portion 221 of the second external electrode 220, respectively. In the illustrated example, since the spread is further excessively small, the conductive resin film 921 and the conductive resin film 922 do not reach the first external electrode 210 and the second external electrode 220, respectively.

FIG. 4 is a diagram schematically illustrating an electronic apparatus 2103 in which spread of the conductive resin films 921 and 922 is excessively large when compared to those in the electronic apparatus 2101 (FIG. 2). Specifically, as a result of excessively wide extension of the conductive resin films 921 and 922 on the first surface S1, on which the first external electrode 210 and the second external electrode 220 are provided, the conductive resin films 921 and 922 are separated from the substrate 800 due to a shortage of the amount of the conductive resin films 921 and 922 in the vicinity of the substrate 800.

Consequently, the conductive resin films 921 and 922 lose a function for electrical connection. In the illustrated example, the spread is further excessively large, and the conductive resin films 921 and 922 are in contact with each other on the first surface S1. This creates a malfunction in that the first external electrode 210 and the second external electrode 220 are electrically shorted.

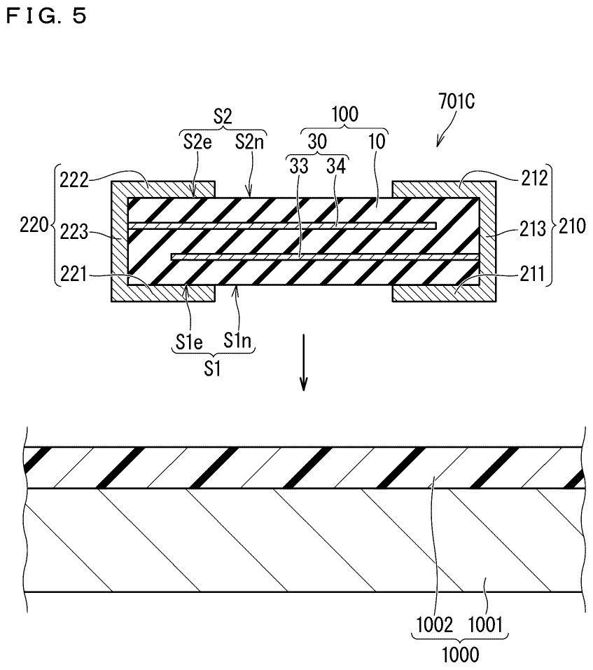

FIGS. 5 to 10 are partial cross-sectional views schematically illustrating first to six steps of a method of manufacturing the ceramic electronic component 701 (FIG. 1).

With reference to the upper portion of FIG. 5, a ceramic electronic component 701C (FIG. 5) to be the ceramic electronic component 701 with the fluorine compound 400 (FIG. 1) is prepared. In other words, the ceramic electronic component 701C without the fluorine compound 400 is manufactured. The ceramic electronic component 701C may be manufactured using a known manufacturing method.

With reference to the lower portion of FIG. 5, an instrument 1000 for surface modification is prepared. The instrument 1000 has a surface including a fluorine compound layer 1002 (a fluorine compound portion). The fluorine compound layer 1002 is supported by a supporting plate 1001 (a supporter) in the present embodiment. The fluorine compound layer 1002 may be made of, for example, viton (registered trademark) or another fluororesin. The instrument 1000 may be manufactured by, for example, applying liquid fluoroelastomer to the supporting plate 1001 and then curing this liquid fluoroelastomer to change the liquid fluoroelastomer into a cured product made of a fluorine compound. In this case, the fluorine compound layer 1002 is an elastomer layer.

Next, as indicated by the arrow in FIG. 5, the ceramic electronic component 701C is opposed to the fluorine compound layer 1002. Specifically, the first surface S1, on which the first portion 211 of the first external electrode 210 and the first portion 221 of the second external electrode 220 are provided, is opposed to the fluorine compound layer 1002.

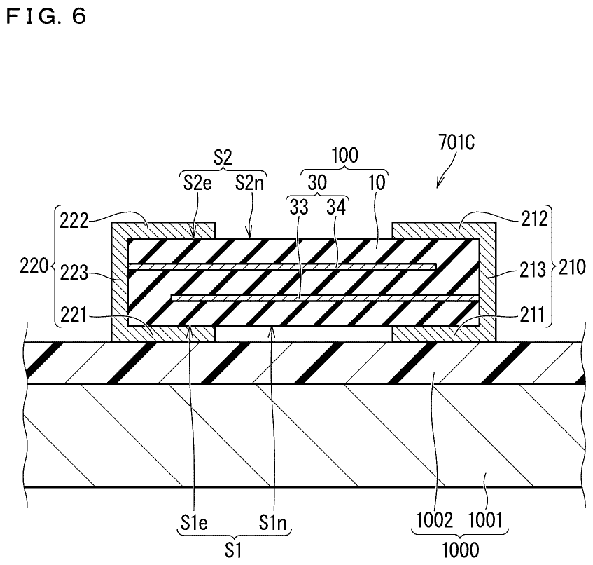

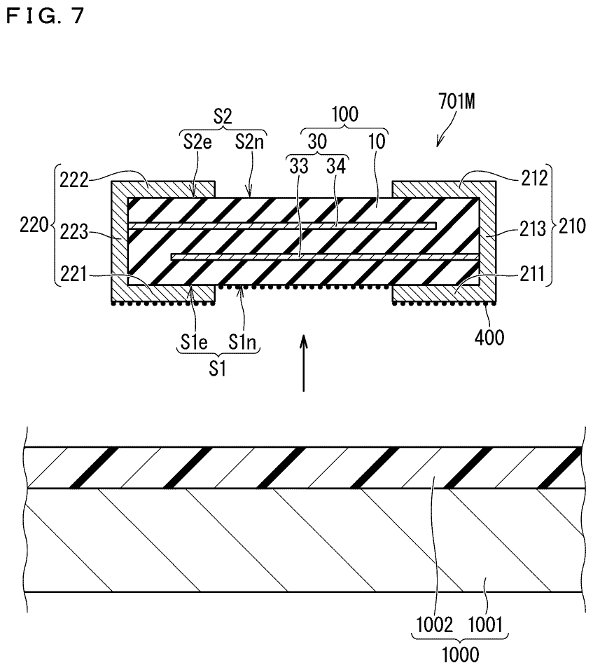

With reference to FIG. 6, the first portion 211 of the first external electrode 210 and the first portion 221 of the second external electrode 220 are disposed on the fluorine compound layer 1002. Specifically, a contact state between the fluorine compound layer 1002 and each of the first portion 211 of the first external electrode 210 and the first portion 221 of the second external electrode 220 is obtained. When the fluorine compound layer 1002 is an elastomer layer, the contact state can be obtained in a larger area through deformation of the fluorine compound layer 1002 to correspond to the surfaces of the first portion 211 and the first portion 221. Furthermore, the contact state can be easily maintained with the adhesion on the surface of the fluorine compound layer 1002. Using the fluorine compound layer 1002 as a material source, a surface modification treatment, that is, a fluorine adhesion treatment is performed by maintaining this contact state, for example, for approximately two hours. This treatment can be enhanced by heating the fluorine compound layer 1002. With reference also to FIG. 7, a ceramic electronic component 701M in which the fluorine compound 400 (see FIG. 1) exits on the first portion 211 and the first portion 221 is obtained through this fluorine adhesion treatment.

In the aforementioned fluorine adhesion treatment, the fluorine compound 400 may be made to exist on the second region Sin of the first surface S1 in the ceramic portion 10. In the fluorine adhesion treatment, the fluorine compound layer 1002 may be in contact with the second region S1n. In such a case, more of the fluorine compound 400 is formed on the second region S1n. This contact state is easily obtained when the fluorine compound layer 1002 is an elastomer layer, and is easily maintained with the adhesion on the surface of the fluorine compound layer 1002.

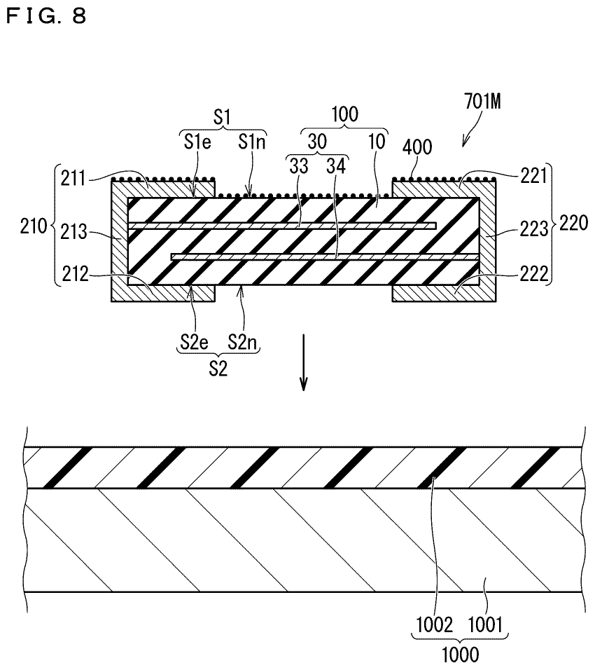

With reference to FIG. 8, the ceramic electronic component 701M is opposed to the fluorine compound layer 1002. Specifically, the second surface S2, on which the second portion 212 of the first external electrode 210 and the second portion 222 of the second external electrode 220 are provided, is opposed to the fluorine compound layer 1002.

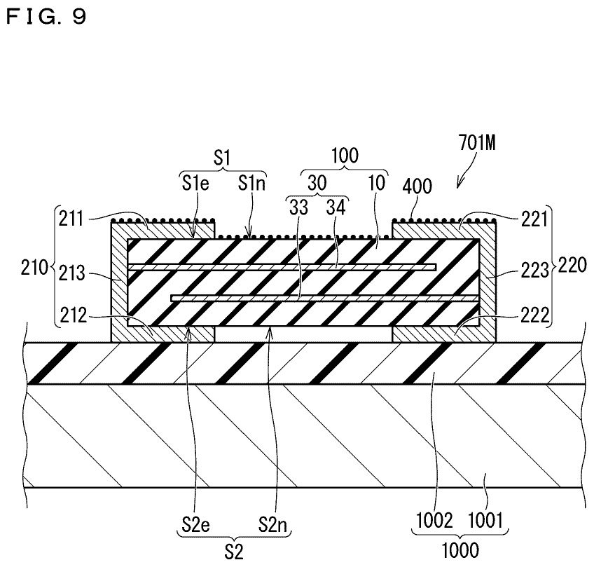

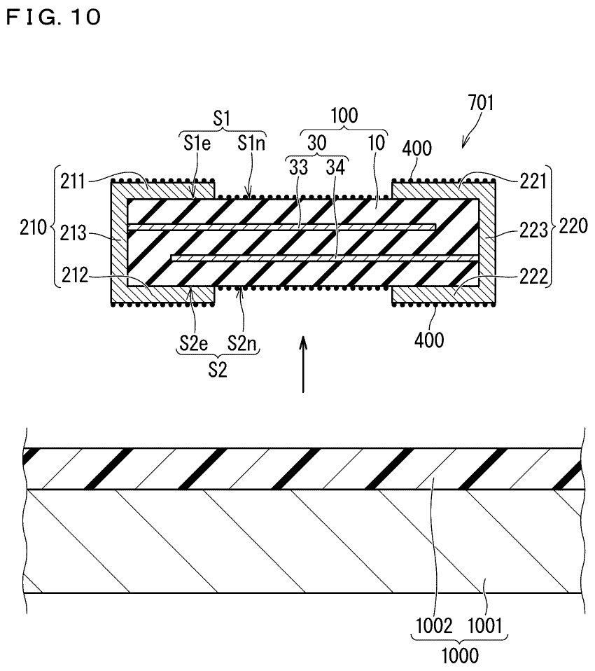

With reference to FIG. 9, the second portion 212 of the first external electrode 210 and the second portion 222 of the second external electrode 220 are disposed on the fluorine compound layer 1002. Specifically, a contact state between the fluorine compound layer 1002 and each of the second portion 212 of the first external electrode 210 and the second portion 222 of the second external electrode 220 is obtained. When the fluorine compound layer 1002 is an elastomer layer, the contact state can be obtained in a larger area through deformation of the fluorine compound layer 1002 to correspond to the surfaces of the second portion 212 and the second portion 222. Furthermore, the contact state can be easily maintained with the adhesion on the surface of the fluorine compound layer 1002. Using the fluorine compound layer 1002 as a material source, the fluorine adhesion treatment is performed by maintaining this contact state, for example, for approximately two hours. This treatment can be enhanced by heating the fluorine compound layer 1002. With reference also to FIG. 10, the ceramic electronic component 701 in which the fluorine compound 400 exits on the second portion 212 and the second portion 222 is obtained through this fluorine adhesion treatment.

As a modification, the fluorine adhesion treatment may end at the time of FIG. 7, and the processes in FIGS. 8 and 9 may be omitted. In such a case, the ceramic electronic component 701M (FIG. 7) is obtained in place of the ceramic electronic component 701 as a component for an electronic apparatus.

In the fluorine adhesion treatment, the fluorine compound 400 may be made to exist on the second region S2n of the second surface S2 of the ceramic portion 10. In the fluorine adhesion treatment, the fluorine compound layer 1002 may be in contact with the second region S2n. In such a case, more of the fluorine compound 400 exists on the second region S2n. This contact state is easily obtained when the fluorine compound layer 1002 is an elastomer layer, and is easily maintained with the adhesion on the surface of the fluorine compound layer 1002.

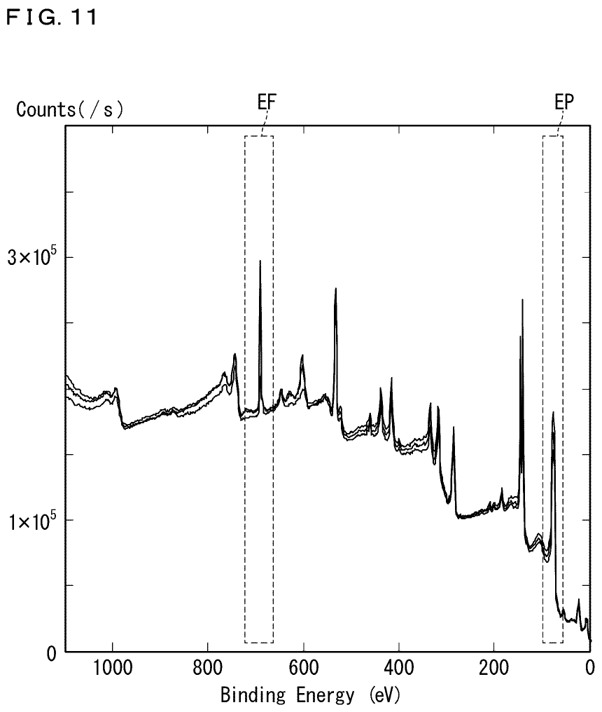

FIG. 11 is a graph illustrating an example of measurement results by XPS on the surface of the external electrode 200 (specifically, the first portion 211 of the first external electrode 210), on three samples (i.e., Example) corresponding to the ceramic electronic component 701. The samples in this drawing have been subjected to the fluorine adhesion treatments (the treatments in FIGS. 6 and 9) at 80° C. for two hours. A broken-line portion EP corresponds to binding energy of a 4f peak of platinum (Pt) contained in a Pt electrode as the first external electrode 210. Furthermore, a broken-line portion EF corresponds to binding energy of a Is peak of fluorine (F) contained in the fluorine compound 400 on the surface of the first external electrode 210. Hereinafter, a ratio of an effective peak height of the Is peak of F to an effective peak height of the 4f peak of Pt will be referred to as F/Pt. The details on the effective peak height will be described later.

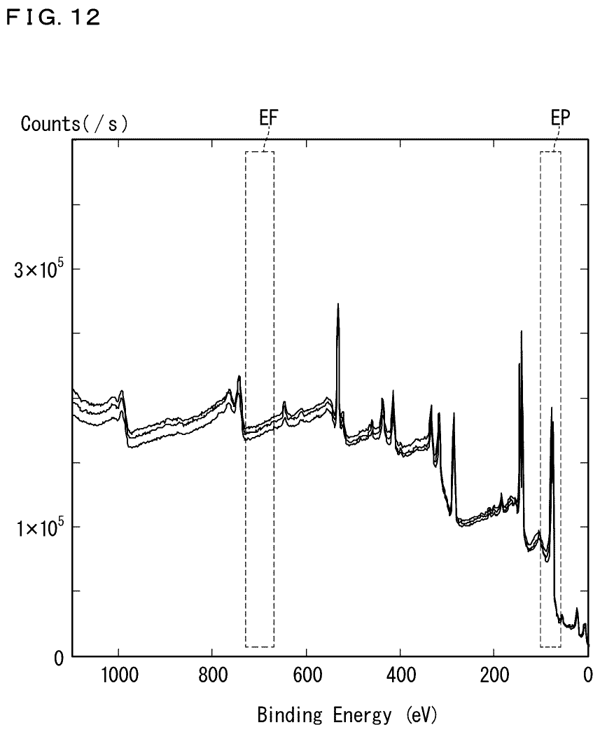

FIG. 12 is a graph illustrating an example of measurement results by XPS on the surface of the external electrode 200 (specifically, the first portion 211 of the first external electrode 210), on three samples of the ceramic electronic component 701C (see FIG. 5) without the fluorine compound 400 (see FIG. 1). In other words, FIG. 12 illustrates the measurement results by XPS in the case of a comparative example without the fluorine adhesion treatment. These measurement results have not confirmed the Is peak of F in the broken-line portion EF, unlike FIG. 11. According to a comparison between FIGS. 11 and 12, the aforementioned value F/Pt can conceivably be used as an indicator of the amount of the fluorine compound 400 on the Pt electrode as the external electrode 200.

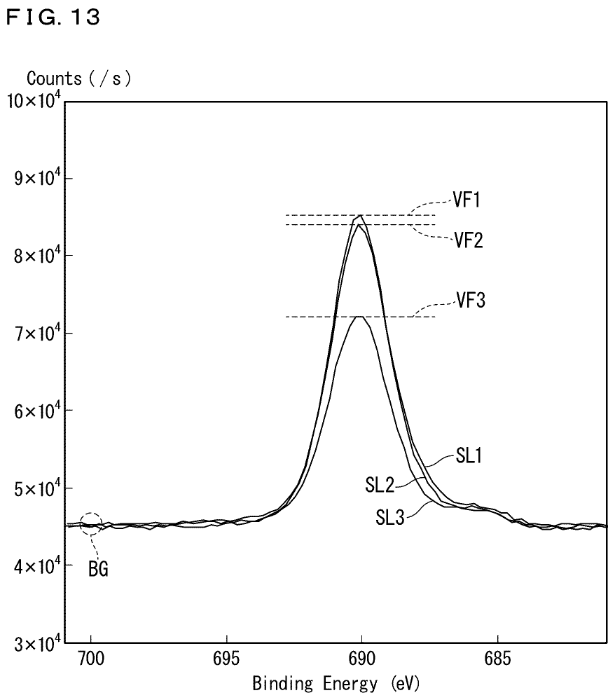

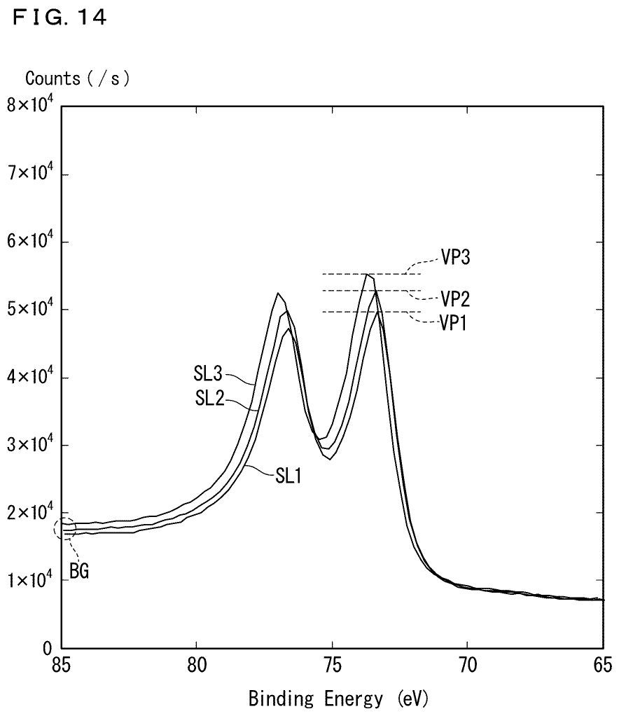

Each of FIGS. 13 and 14 is a graph illustrating an example of more accurate XPS measurement results on three samples (specifically, samples SL1 to SL3) in the broken-line portions EF and EP (FIG. 11). An effective peak height of 1s of F and an effective peak height of 4f of Pt for calculating the ratio F/Pt are specifically calculated as follows herein. First, the effective peak height of the Is peak of F is calculated using a height of a flat portion adjacent to the Is peak in an energy region lower than the Is peak as a background BG with reference to the XPS measurement results in FIG. 13. For example, the height in the vicinity of 700 eV is used as the background BG. The background BG is subtracted from the maximum peak height of 1s of F (e.g., one of the peak heights VF1 to VF3) to calculate the effective peak height. Furthermore, the effective peak height of the 4f peak of Pt is calculated using a height of a flat portion adjacent to the 4f peak in an energy region lower than the 4f peak as a background BG. For example, the height in the vicinity of 85 eV is used as the background BG. The background BG is subtracted from the maximum peak height of 4f of Pt (e.g., one of the peak heights VP1 to VP3) to calculate the effective peak height.

ESCA-5600ci of ULVAC-PHI, Inc. was used for the aforementioned XPS. An Al source of 300 W was monochromated and used as an X-ray source. The spot size of the X ray was 0.5 mm in diameter.

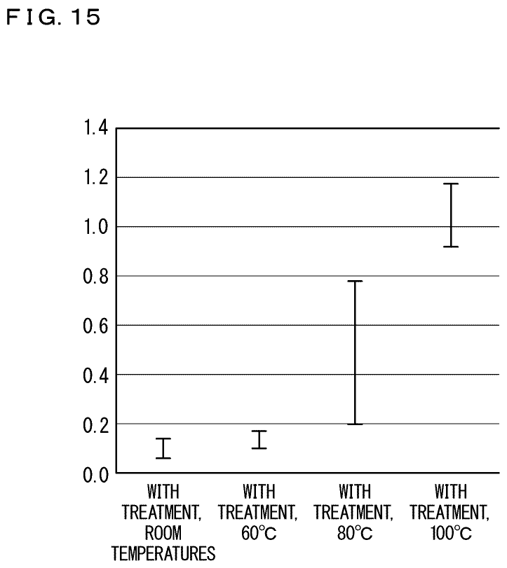

Table 1 below indicates results on studying yield rates of electronic apparatuses (see FIGS. 2 to 4) on each of which a ceramic electronic component is mounted and the value F/Pt, in the absence of the fluorine adhesion treatment and in the presence of the fluorine adhesion treatment when treatment temperatures are room temperatures, 60° C., 80° C., and 100° C. FIG. 15 is a graph illustrating distribution ranges of F/Pt in this Table 1.

TABLE 1

| FLUORINE | | | |
|---|---|---|---|
| ADHESION | YIELD | SAMPLE | |
| TREATMENT | RATE | NUMBER | F/Pt |
| WITHOUT | 1/5 | 1 | NO F PEAK |
| TREATMENT | | 2 | NO F PEAK |
| | | 3 | NO F PEAK |
| | | 4 | NO F PEAK |
| | | 5 | NO F PEAK |
| WITH | 3/5 | 1 | 0.10 |
| TREATMENT, | | 2 | 0.10 |
| ROOM | | 3 | 0.14 |
| TEMPERATURE | | 4 | 0.06 |
| | | 5 | 0.08 |
| WITH | 4/5 | 1 | 0.18 |
| TREATMENT, | | 2 | 0.12 |
| 60° C. | | 3 | 0.18 |
| | | 4 | 0.14 |
| | | 5 | 0.10 |
| WITH | 5/5 | 1 | 0.78 |
| TREATMENT, | | 2 | 0.60 |
| 80° C. | | 3 | 0.46 |
| | | 4 | 0.51 |
| | | 5 | 0.20 |
| WITH | 4/5 | 1 | 1.08 |
| TREATMENT, | | 2 | 1.05 |
| 100° C. | | 3 | 1.18 |
| | | 4 | 1.06 |
| | | 5 | 0.92 |

Here, the aforementioned yield rates were calculated by regarding, as a conforming item, an electronic apparatus obtained by mounting a sample if the electronic apparatus matches the electronic apparatus 2001 (FIG. 2), and regarding the electronic apparatus as a nonconforming item if the electronic apparatus matches the electronic apparatus 2002 (FIG. 3) or the electronic apparatus 2003 (FIG. 4). In the table above, “NO F PEAK” in the column of F/Pt represents that the 1s peak of F was not significantly detected.

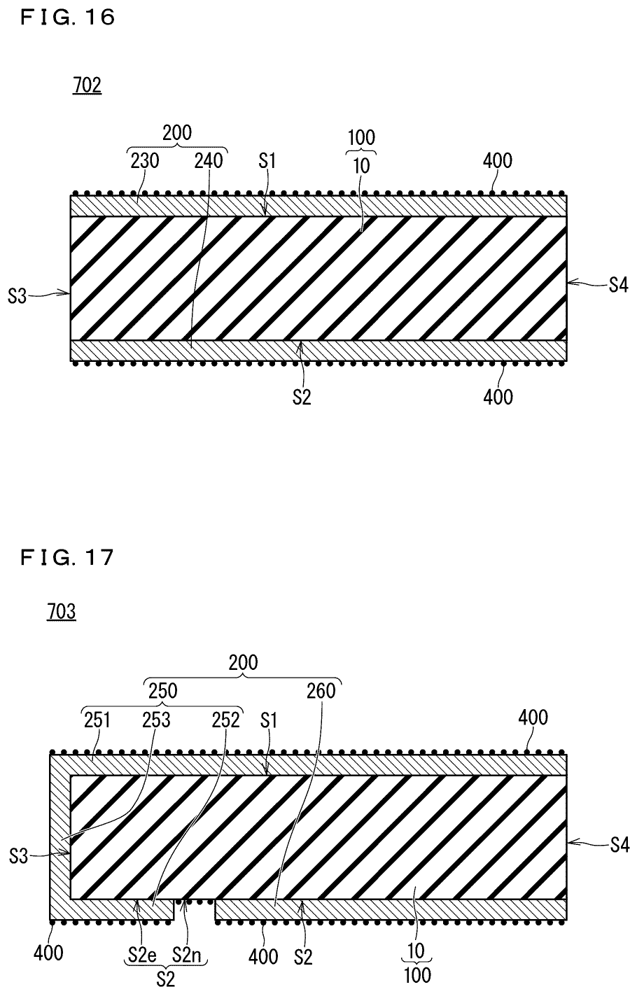

With reference to the table above, it is clear that the yield rate “WITH TREATMENT” has been improved more than that “WITHOUT TREATMENT”. The reason why the yield rate without the treatment is low is because it is conceivable that the surface without the treatment has no control over a surface state and thus, variations in the wettability with a liquid resin material for forming the conductive resin films 921 and 922 (FIGS. 2 to 4) are significant. Specifically, it is conceivable that the wettability of a surface without any treatment is significantly affected by a substance adsorbed on the surface without any particular control (e.g., moisture or organic matters). The ratios of F/Pt in the cases of “WITH TREATMENT” in Table 1 were in a range larger than or equal to 0.06 and smaller than or equal to 1.18 (see FIG. 16).

Furthermore, when comparisons were made among the cases at the room temperatures, 60° C., 80° C., and 100° C. as the treatment temperatures, the yield rates at 60° C., 80° C., and 100° C. were higher than those at the room temperatures. The ratios of F/Pt in these cases were in a range larger than or equal to 0.10 and smaller than or equal to 1.18 (see FIG. 16). Particularly, it is clear that the yield rate is maximized at 80° C. The ratios of F/Pt in this case were in a range larger than or equal to 0.20 and smaller than or equal to 0.78 (see FIG. 16). Considering that F/Pt increases as the temperature of the fluorine adhesion treatment is higher, it is conceivable that setting F/Pt to a value that is neither an excessively large value nor an excessively small value optimizes the wettability, and thus maximizes the yield rate. Specifically, when F/Pt is excessively small, it is conceivable that control over the wettability tends to be insufficient because contribution of the fluorine adhesion treatment is small. Furthermore, when F/Pt is excessively large, it is assumed that the wettability becomes too low because the influence of the fluorine compound 400 is excessively large.

The external electrode 200 may be made of not Pt but another metal (hereinafter also referred to as a metal M). In such a case, a ratio F/M similar to F/Pt is calculated based on the XPS measurement results, using an appropriate peak of the metal M in place of the 4f peak of Pt. Next, a peak ratio with a favorable numerical range as described above is obtained by multiplying F/M by a correction coefficient C. It is conceivable that the correction coefficient C can be easily empirically obtained by, for example, subjecting a plate made of Pt and a plate made of the metal M to the fluorine adhesion treatment under common conditions and then performing XPS on the plates. Specifically, the correction coefficient C is determined such that a common peak ratio is obtained under the common conditions. When the metal M is an alloy of elements E_{A}, E_{B}, . . . , an effective peak height of the metal M may be calculated from an effective peak height of the element E_{A}+an effective peak height of the element E_{B}+ . . . .

According to the present embodiment, the fluorine compound 400 exists on the surfaces of the first portions 211 and 221 of the external electrode 200. The wettability of the first portions 211 and 221 of the external electrode 200 with a resin material for forming the conductive resin films 921 and 922 can be controlled by adjusting the amount of this fluorine compound 400. This can optimize the wettability of the external electrode 200. Thus, the mounting reliability of the ceramic electronic component 701 can be enhanced.

As a modification, insulating resin films having shapes similar to those of the conductive resin films 921 and 922 may be used in place of the conductive resin films 921 and 922. In this case, a component for electrical connection between the first external electrode 210 and the wiring portion 803, and a component for electrical connection between the second external electrode 220 and the wiring portion 804 may be provided. These components may be covered with the insulating resin films. The insulating resin films are provided for enhancing the reliability for mounting the ceramic electronic component 701 on the substrate 800. Depending on the specification of the electronic apparatus 2001, a specific object of the insulating resin films is typically at least one of protection of a portion for electrical connection to the substrate 800 or reinforcement of a mechanical connection to the substrate 800, for the ceramic electronic component 701.

In this modification, when the shapes of the insulating resin films correspond to the shapes of the conductive resin films 921 and 922 in FIG. 2, the insulating resin films have optimal spread. On the other hand, when the shapes of the insulating resin films correspond to the shapes of the conductive resin films 921 and 922 in FIG. 3 or 4, portions to be protected by the insulating resin films are not protected.

The insulating resin films are preferably made of an insulator, for example, an epoxy resin in terms of avoiding causing an unintended electrical connection. The insulating resin films are formed by applying and curing a liquid resin material. Thus, spread of the insulating resin films is significantly affected by the wettability of the ceramic electronic component 701 with the liquid resin material. The amount of the liquid resin material to be applied for forming each of the insulating resin films is normally predefined, for example, approximately 10 micro litter.

### Embodiment 2

FIG. 16 is a cross-sectional view schematically illustrating a structure of a ceramic electronic component 702 according to Embodiment 2. The ceramic electronic component 702 includes a first external electrode 230 and a second external electrode 240 as the at least one external electrode 200, in place of the first external electrode 210 and the second external electrode 220 (FIG. 2). The first external electrode 230 is disposed on the first surface S1, and substantially on the entirety of the first surface S1 in the illustrated example. The first external electrode 230 need not be disposed on a surface except the first surface S1. The second external electrode 240 is disposed on the second surface S2, and substantially on the entirety of the second surface S2 in the illustrated example. The second external electrode 240 need not be disposed on a surface except the second surface S2. In the present embodiment, the internal electrode layers 33 and 34 (FIG. 2) are not necessary.

Since the structure except the described structure is almost the same as that according to Embodiment 1, the same reference numerals are assigned to the same or corresponding elements and the description will not be repeated.

### Embodiment 3

FIG. 17 is a cross-sectional view schematically illustrating a structure of a ceramic electronic component 703 according to Embodiment 3. The ceramic electronic component 703 includes a first external electrode 250 and a second external electrode 260 as the at least one external electrode 200, in place of the first external electrode 210 and the second external electrode 220 (FIG. 2).

The first external electrode 250 includes a first portion 251 located on the first surface S1 of the main body 100. In the present embodiment, the first external electrode 250 includes a second portion 252 located on the second surface S2 of the main body 100, and a third portion 253 located on a part of the third surface S3 of the main body 100. The first portion 251 is substantially disposed on the entirety of the first surface S1 in the illustrated example.

The second external electrode 260 is disposed on the second surface S2, away from the first external electrode 250. The second external electrode 260 need not be disposed on a surface except the second surface S2. In the present embodiment, the internal electrode layers 33 and 34 (FIG. 2) are not necessary.

Since the structure except the described structure is almost the same as that according to Embodiment 1, the same reference numerals are assigned to the same or corresponding elements and the description will not be repeated.

The structures described in Embodiments and the modifications can be appropriately combined or omitted unless any contradiction occurs.

What is claimed is:

1. A ceramic electronic component, comprising:
a main body having a first surface and a second surface opposite to the first surface, the main body including a ceramic portion; and
at least one external electrode including a first portion on the first surface of the main body,
wherein a fluorine compound exists on a surface of the first portion of the at least one external electrode.

2. The ceramic electronic component according to claim 1,
wherein the fluorine compound exists on the surface of the first portion of the at least one external electrode at a peak ratio larger than or equal to 0.06 and smaller than or equal to 1.18.

3. The ceramic electronic component according to claim 2,
wherein the fluorine compound exists on the surface of the first portion of the at least one external electrode at a peak ratio larger than or equal to 0.10 and smaller than or equal to 1.18.

4. The ceramic electronic component according to claim 3,
wherein the fluorine compound exists on the surface of the first portion of the at least one external electrode at a peak ratio larger than or equal to 0.20 and smaller than or equal to 0.78.

5. The ceramic electronic component according to claim 1,
wherein the at least one external electrode includes a second portion on the second surface of the main body.

6. The ceramic electronic component according to claim 5,
wherein the fluorine compound exists on a surface of the second portion of the at least one external electrode.

7. The ceramic electronic component according to claim 1,
wherein the main body has a third surface connecting the first surface to the second surface, and
the at least one external electrode includes a third portion on the third surface of the main body.

8. The ceramic electronic component according to claim 7,
wherein the main body includes a first internal electrode layer connected to the third portion of the at least one external electrode.

9. The ceramic electronic component according to claim 7,
wherein the main body has a fourth surface connecting the first surface to the second surface, and
the at least one external electrode includes a fourth portion on the fourth surface of the main body.

10. The ceramic electronic component according to claim 9,
wherein the main body includes a first internal electrode layer connected to the third portion of the at least one external electrode, and a second internal electrode layer connected to the fourth portion of the at least one external electrode.

11. The ceramic electronic component according to claim 1,
wherein the first surface of the main body includes:
a first region covered with the at least one external electrode; and
a second region not covered with the at least one external electrode, and
the fluorine compound exists on the second region of the first surface of the main body.

12. The ceramic electronic component according to claim 1,
wherein the at least one external electrode includes an electrode containing platinum.

13. A method of manufacturing a ceramic electronic component, the method comprising:
preparing a ceramic electronic component including an external electrode; and
bringing the external electrode into contact with a fluorine compound layer.
